(19) United States
(12) Patent Application Publication
(10) Pub. No.: US 2006/0182950 A1
(43) Pub. Date: Aug. 17, 2006

(54) Easy-to-tear wrapping tape

(75) Inventors: Petra Yun, Hamburg (DE); Bernhard Mussig, Seevetal (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, HAMBURG (DE)

(21) Appl. No.: 10/539,784

(22) PCT Filed: Nov. 20, 2003
(86) PCT No.: PCT/EP03/12976

§ 371 Date: Mar. 7, 2006

(30) Foreign Application Priority Data
Dec. 19, 2002 (DE) 102 60 072.4

(51) Int. Cl. B32B 7/12

(52) U.S. Cl. 428/343

(57) ABSTRACT

An easy-to-tear halogen-free wrapping tape, comprised of a film layer and of an adhesive layer the film layer containing a copolymer of (a) α-olefin of formula R—CH═CH2, in which R represents hydrogen or an alkyl radical having 1 to 10 carbon atoms; (b) an α,β-ethylenically unsaturated carboxylic acid comprised of 3 to 8 carbon atoms, and; (c) optionally containing an additional monoethylenically unsaturated monomer; 10 to 90% of the carboxylic acid groups of the copolymer being substituted by neutralizing with metal ions.

The present invention relates to a halogen-free, easy-tear wrapping, or winding, tape, which is composed of a film and of an adhesive layer. The winding tape is used, for example, for wrapping ventilation lines in air-conditioning units, wires or cables, and is suitable in particular for cable harnesses in vehicles or field coils for picture tubes. The winding tape serves in these cases for bundling, insulating, marking, sealing or protecting. The invention further embraces a process for producing the film of the invention.

Cable winding tapes and insulating tapes are normally composed of plasticized PVC film with a coating of pressure-sensitive adhesive on one side. There is an increased desire to eliminate disadvantages of these products. These disadvantages include plasticizer evaporation and high halogen content.

The plasticizers in conventional insulating tapes and cable winding tapes gradually evaporate, leading to a health hazard; the commonly used DOP, in particular, is objectionable. Moreover, the vapors deposit on the glass in motor vehicles, impairing visibility (and hence, to a considerable extent, driving safety), this being known to the skilled worker as fogging (DIN 75201). In the event of even greater vaporization as a result of higher temperatures, in the engine compartment of vehicles, for example, or in electrical equipment in the case of insulating tapes, the winding film is embrittled by the attendant loss of plasticizer.

Plasticizers impair the fire performance of unadditived PVC, something which is compensated in part by adding antimony compounds, which are highly objectionable from the standpoint of toxicity, or by using chlorine- or phosphorus-containing plasticizers.

Against the background of the debate concerning the incineration of plastic wastes, such as shredder waste from vehicle recycling, for example, there exists a trend toward reducing the halogen content and hence the formation of dioxins. In the case of cable insulation, therefore, the wall thicknesses are being reduced, and the thicknesses of the PVC film are being reduced in the case of the tapes used for wrapping. The standard thickness of the PVC films for winding tapes is 85 to 200 μm. Below 85 μm, considerable problems arise in the calendering operation, with the consequence that virtually no such products with reduced PVC content are available.

The customary winding tapes comprise stabilizers based on toxic heavy metals, usually lead, more rarely cadmium or barium.

State of the art for the bandaging of sets of leads are winding films with and without an adhesive coating, said films being composed of a PVC carrier material which has been made flexible through incorporation of considerable amounts (30 to 40% by weight) of plasticizer. The carrier material is coated usually on one side with a self-adhesive mass based on SBR rubber. Considerable deficiencies of these adhesive PVC winding tapes are their low aging stability, the migration and evaporation of plasticizer, their high halogen content, and a high smoke gas density in the event of fire. JP 10 001 583 A1, JP 05 250 947 A1, JP 2000 198 895 A1 and JP 2000 200 515 A1 describe typical plasticized PVC adhesive tapes. In order to obtain higher flame retardancy in the plasticized PVC materials it is usual, as described for example in JP 10 001 583 A1, to use the highly toxic compound antimony oxide.

There are attempts to use wovens or nonwovens instead of plasticized PVC film; however, the products resulting from such attempts are but little used in practice, since they are relatively expensive and differ sharply from the habitual products in terms of handling (for example, hand tearability, elastic resilience) and under service conditions (for example, resistance to service fluids, electrical properties), with—as set out below—particular importance being attributed to the thickness.

DE 200 22 272 U1, EP 1 123 958 A1 and WO 99/61541 A1 describe adhesive winding tapes comprising a clothlike (woven) or weblike (nonwoven) carrier material. These materials are distinguished by a very high tensile strength. A consequence of this, however, is the disadvantage that, when being processed, these adhesive tapes cannot be torn off by hand without the assistance of scissors or knives.

Tearability, stretchability and flexibility are the major requirements imposed on adhesive winding tapes, in order to allow crease-free winding and flexible cable harnesses to be produced.

In modern-day vehicle construction, on the one hand the cable harnesses are becoming more and more thick and rigid as a result of the multiplicity of electrical consumers and the increased transfer of information within vehicles, while on the other hand the space for their installation is becoming ever more greatly restricted, and, consequently, assembly (leadthrough when laying cables within the vehicle body) is becoming more problematic. As a result, a thin film tape is advantageous. Moreover, for efficient and cost-effective cable-harness production, cable winding tapes are expected to have easy and quick processing qualities.

Winding tapes based on plasticized PVC films are used in automobiles for bandaging electrical leads to form cable harnesses. Although initially the primary factor in technical development was to improve the electrical insulation when using these winding tapes, which were originally developed as insulating tapes, cable set tapes of this kind are now required to fulfill further functions, such as the bundling and permanent fixing of a multiplicity of individual cables to form a stable cable strand, and the protection of the individual cables and the entire cable strand against mechanical, thermal, and chemical damage.

DE 199 10 730 A1 describes a laminate carrier which is composed of velour or foam and a nonwoven, and which is adhesively bonded by means of a double-sided adhesive tape or using a hotmelt adhesive.

EP 0 886 357 A2 describes a triple-ply protective sheath comprising a spunbonded web, a PET knit, and a strip of foam or felt, which are laminated together, the protective sheath additionally being provided, at least in part, and very complicatedly, with adhesive strips and touch-and-close fastener systems.

EP 1 000 992 A1 describes a holed cotton nonwoven which has a polyethylene coating 10 to 45 μm thick and also has an additional release coating.

DE-U 94 01 037 describes an adhesive tape having a tapelike textile carrier composed of a stitchbonded web formed in turn from a multiplicity of sown-in stitches which run parallel to one another. The web proposed therein is said to have a thickness of 150 to 400 μm for a basis weight of 50 to 200 g/m².

DE 44 42 092 C1 describes an adhesive tape based on stitchbonded web which is coated on the reverse of the carrier. DE 44 42 093 C1 is based on the use of a web as a carrier for an adhesive tape, said web being a cross-laid fiber web which is reinforced by the formation of loops from the fibers of the web, i.e., a web known to the skilled worker under the name Malifleece. DE 44 42 507 C1 discloses an adhesive tape for cable bandaging, but bases it on what are known as Kunit or Multiknit webs. All three documents use webs having a basis weight of approximately 100 g/m², as can be inferred from the examples.

DE 195 23 494 C1 discloses the use of an adhesive tape with a nonwoven material carrier having a thickness of 400 to 600 μm for bandaging cable harnesses, said tape being coated on one side with an adhesive.

DE 199 23 399 A1 discloses an adhesive tape having a tapelike carrier made of nonwoven material, which is coated on at least one side with an adhesive, the nonwoven web having a thickness of 100 μm to 3000 μm, especially 500 to 1000 μm.

Webs with this kind of thickness make the cable harnesses even thicker and more inflexible than conventional PVC tapes, albeit with a positive effect on soundproofing, which is of advantage only in certain areas of cable harnesses. Webs, however, lack stretchability and exhibit virtually no resilience. This is of importance on account of the fact that thin branches of cable harnesses must be wound with sufficient tautness that, when installed, they do not hang down loosely, and such that they can easily be positioned before the plugs are clipped on and attached.

A further disadvantage of textile adhesive tapes is the low breakdown voltage of about 1 kV, since only the adhesive layer is insulating. Film-based tapes, in contrast, are situated at more than 5 kV; they have good voltage resistance.

Winding films and cable insulation comprising thermoplastic polyester have been used on a trial basis for producing cable harnesses. They have considerable deficiencies in terms of their flexibility, processing qualities, aging stability or compatibility with the cable materials. The gravest disadvantage of polyester, however, is its considerable sensitivity to hydrolysis, which rules out use in automobiles on safety grounds.

DE 100 02 180 A1, JP 10 149 725 A1, JP 09 208 906 A1 and JP 05 017 727 A1 describe the use of halogen-free thermoplastic polyester carrier films. JP 07 150 126 A1 describes a flame-retardant winding film comprising a polyester carrier film which comprises a brominated flame retardant.

Also described in the patent literature are winding tapes comprising polyolefins. They comprise either halogenated flame retardants or very high amounts of fillers, which cause low flexibility, stretch whitening and very low tensile strength.

WO 00/71634 A1 describes an adhesive winding tape whose film is composed of an ethylene copolymer base material. The carrier film comprises the halogenated flame retardant decabromodiphenyl oxide. The film softens, however, even below a temperature of 95° C.

WO 97/05206 A1 describes a halogen-free adhesive winding tape whose carrier film is composed of a polymer blend of low-density polyethylene and an ethylene/vinyl acetate or ethylene/acrylate copolymer. The flame retardant used is 20 to 50% by weight of aluminum hydroxide or ammonium polyphosphate. A considerable disadvantage of the carrier film is, again, a softening temperature below 100° C. To counter this the use of silane crosslinkers is described. The subject matter of the invention additionally features low flexibility, stretch whitening, and very low tensile strength.

Analogous problems also occur with the filler-containing adhesive insulating tapes recited below.

WO 99/35202 A1 and U.S. Pat. No. 5,498,476 A1 describe a carrier film material comprising a blend of EPDM and EVA in combination with ethylenediamine diphosphate as flame retardant. Like ammonium polyphosphate, this flame retardant is highly sensitive to hydrolysis. In combination with EVA, moreover, there is an embrittlement on aging. The insulating tapes described are too thick and far too inflexible for cable harness winding tapes.

EP 0 953 599 A1 claims a polymer blend of LLDPE and EVA for applications as cable insulation and as film material. The flame retardant described comprises a combination of magnesium hydroxide of specific surface area and red phosphorus.

A very similar combination is described in EP 1 097 976 A1. In this case the LLDPE is replaced by a PP polymer. A disadvantage, however, is the resultant low flexibility. For blending with EVA or EEA it is maintained that the film has sufficient flexibility. From the literature, however, the skilled worker is aware that these polymers are blended with polypropylene in order to improve flame retardancy. The products described have a film thickness of 0.2 mm: this thickness alone rules out flexibility in the case of filled polyolefin films, since flexibility is dependent on the thickness to the 3rd power. With the extremely low melt indices of the polypropylenes used, as the skilled worker is aware, the described process of extrusion is virtually impossible to carry out on a production installation, and certainly not for a thin film in conformity to the art, and certainly not in the case of use in combination with the high amounts of filler that are described.

JP 2001 049 208 A1 describes an oil-resistant and heat-resistant film for an adhesive tape, in which both layers are composed of a mixture of EVA or EEA, peroxide crosslinker, silane crosslinker, catalyst for the silanol condensation, and flame retardant and one of the layers additionally comprises polypropylene. This film solves neither the problem of the low flexibility of a filled polypropylene film nor that of the exacting requirements imposed on aging stability.

JP 09 310 048 A1 describes a film carrier comprising polyolefin, flame retardant, HALS light stabilizer and hydrotalcite as acid scavenger for the EVA. This film has neither a high flexibility nor a high aging stability as its objective.

Both attempted solutions build on the known synergistic flame retardancy effect of red phosphorus with magnesium hydroxide. The use of elemental phosphorus, however, harbors considerable disadvantages and risks. In the course of processing, foul-smelling and highly toxic phosphine is released. A further disadvantage arises from the development of very dense white smoke in the event of fire. Moreover, only brown to black products can be produced, whereas for color marking winding films are used in a broad color range.

The specified patents of the prior art, despite the disadvantages identified, do not lead to films which also achieve the further requirements such as hand tearability, flexibility, thermal stability, compatibility with polyolefin cable insulation, avoidance of stretch whitening, or sufficient unwind force. Furthermore, the processing properties in film production operations, and fogging numbers, remain questionable. The films filled with salts such as ammonium polyphosphate or hydroxides such as magnesium hydroxide or aluminum hydroxide have a certain conductivity and so give breakdown voltages of around 3 kV/100 μm. In order to improve the hand tearability of polyolefin films it is possible, in addition to flame retardants, to use other fillers as well, such as chalk or talc, but these likewise considerably reduce tensile strength and breakdown voltage.

Copolymers containing ionogenic groups have been mentioned for other applications with pressure-sensitive adhesives. Although the applications concerned do not relate to winding tapes, and although such copolymers are not used for the purpose of obtaining a product which is flexible and easy to tear, they will be addressed.

U.S. Pat. No. 6,045,882 A describes a multilayer film which is blown and then biaxially drawn, this film preferably comprising an ionogenic polymer. It is distinguished by particularly high tensile strength, low friction coefficients, and transparency.

WO 01/00480 A1 describes packaging comprising a high-tensile-strength film of polyethylene and a high-tensile-strength adhesive tape (tear-open strip). In one specific embodiment the polyethylene is an ionogenic ethylene copolymer.

JP 48 072 238 A describes an adhesive tape comprising an oriented polypropylene film to which is admixed an ethylene polymer, preferably an ionogenically modified ethylene polymer, for the purpose of increasing the tensile strength of the film.

JP 56 109 274 A1 describes an adhesive tape comprising a film of a copolymer of propylene and methylpentene, where a layer of ionically modified polyolefin serves as adhesion promoter to a hotmelt adhesive.

WO 01/85444 A1 describes an adhesive tape comprising a hard foil or film (aluminum, metallized polyester or polyimide), a soft layer (for example, polyurethane or polyethylene, the latter also including EVA or ethylene copolymers having ionogenic groups), and an adhesive layer. A particular feature of the invention is a particularly high electromagnetic shielding (EMI) and voltage resistance. The low flexibility of the hard foil or film is improved by embossing. The subject matter of the invention is not easy to tear.

WO 01/44398 A1 describes an adhesive tape with a film comprising a polymer mixture. One component consists of one of the standard commercial thermoplastic polymers, the other of a thermoplastic elastomer (for example, polyamide, polyurethane or polyolefin, it being possible for this elastomer also to contain ionogenic groups). Tearability is not provided by the raw materials, but is achieved by monoaxial orientation of the film with subsequent application of a specific embossing.

WO 92/20534 A1 describes a self-adhesive wallpaper with an outer layer of high-melt-index ionomeric polyolefin, containing filler, on which decorative diecuts can be reversibly affixed.

There are a number of film adhesive tapes for packaging purposes, but they are not suitable for use as winding tape. In the case of polyester carriers or oriented polypropylene carriers, they have a very low flexibility. Unoriented polyethylene or polypropylene carriers (from a casting or blowing operation) may well be sufficiently flexible, but do not possess hand tearability and/or clean tearability (high breaking elongation), as even the non-expert is aware from household pouches or carrier bags.

The object remains, therefore, to find a solution for a winding tape which combines the advantages of easy tearability, flexibility, abrasion resistance, high breakdown voltage resistance, absence of stretch whitening, and other mechanical advantages of high-grade PVC winding tapes with the absence of halogen of textile winding tapes and which, furthermore, exhibits superior thermal aging stability, further requirements being the ability to produce the winding tape industrially and, for certain applications, a high fogging number.

It is an object of the present invention to provide flexible, halogen-free, easy-tear winding tapes which allow particularly reliable and rapid wrapping, in particular of wires and cables, for marking, protecting, insulating, sealing or bundling, the disadvantages of the prior art occurring not at all or at least not to the known extent.

In concert with the increasingly complex electronics and the increasing number of electrical consumer units in automobiles, the sets of leads, too, are becoming ever more complex. With increasing cross sections in the cable harnesses, the inductive heating is becoming greater and greater, while the dissipation of heat is going down. As a result there are increases in the thermal stability requirements of the materials used. The PVC materials used as standard for adhesive winding tapes are reaching their limits here. A further object was therefore to find a carrier film material which not only matches but indeed exceeds the thermal stability of PVC.

This object is achieved by means of a winding tape as specified in the main claim. The dependent claims relate to advantageous developments of the winding tape of the invention, to applications thereof, and to processes for producing the winding tape.

The invention accordingly provides an easy-tear, halogen-free winding tape composed of a film and of an adhesive layer. The film comprises a copolymer of
(a) α-olefin of the formula R—CH═CH₂, where R is hydrogen or an alkyl radical having 1 to 10 carbon atoms, and
(b) an α,β-ethylenically unsaturated carboxylic acid of 3 to 8 carbon atoms, and
(c) optionally a further monoethylenically unsaturated monomer, 10 to 90% of the hydrogen atoms of the carboxylic acid groups of the copolymer being substituted by metal ions as a result of neutralization.

The thickness of the winding tape of the invention is in the range from 30 to 180 μm, preferably 50 to 150 μm, in particular 55 to 100 μm. The surface may be textured or smooth. Preferably the surface is made slightly matt. This can be achieved through the use of a filler having a sufficiently high particle size or by means of a roller (for example, embossing roller on the calender or matted chill roll or embossing roller during extrusion).

The winding tape is preferably coated with a pressure-sensitively adhesive layer. In one particular embodiment the film can also be wound without adhesive, although fixing of the winding tape at the end of the winding operation should in that case take place with an adhesive tape.

Very surprisingly, in comparison to PVC as a high-performance material, the thermal aging stability is not poorer but rather is comparable or even better.

The winding tape of the invention is substantially free from volatile plasticizers such as DOP or TOTM, for example, and therefore has excellent fire performance and low emissions (plasticizer evaporation, fogging).

Unforeseeably and surprisingly for the skilled worker a winding tape of this kind can be produced from a film and also an adhesive layer, the film comprising a copolymer of
(a) α-olefin of the formula R—CH═CH₂, where R is hydrogen or an alkyl radical having 1 to 10 carbon atoms, and
(b) an α,β-ethylenically unsaturated carboxylic acid of 3 to 8 carbon atoms, and
(c) optionally a further monoethylenically unsaturated monomer, 10 to 90% of the hydrogen atoms of the carboxylic acid groups of the copolymer being substituted by metal ions as a result of neutralization.

As a result of crosslinking, the winding tape is in fact unmeltable. This is possible as a result of ionizing radiation such as electron beams or γ radiation or peroxides. A further possibility is to modify the copolymer or a polymer of an optional coextrusion layer with silane groups which lead to crosslinking as a result of exposure to (atmospheric) humidity.

The mechanical properties of the winding tape of the invention in md (machine direction) are situated preferably within the following ranges:

force at 1% elongation 0.6 to 4 N/cm, more preferably 1 to 3 N/cm,

force at 100% elongation 5 to 20 N/cm, more preferably 8 to 12 N/cm,

breaking elongation from 200 to 1000%, more preferably from 300 to 400%,

tensile strength in the range from 6 to 40 N/cm, more preferably from 8 to 15 N/cm,

the film having been cut to size using sharp blades for the purpose of determining the data.

The force at 1% elongation is a measure of the rigidity of the film, and the force at 100% elongation is a measure of the conformability when it is wound with sharp deformation as a result of high winding tension. The 100% force, however, must also not be too low, since otherwise the tensile strength is inadequate.

The breakdown voltage is preferably at least 5 kV/100 μm.

The winding tape is produced on a calender or by extrusion, such as by a film-blowing or casting process, for example. Aforementioned processes are described for example in

Ullmann's Encyclopedia of Industrial Chemistry, 6th edition, Wiley-VCH 2002.

The preferred melt index of the copolymer for calender processing is below 5 g/10 min, preferably below 1 g/10 min, and in particular below 0.7 g/10 min. For extrusion processing the preferred melt index is between 0.2 and 10 g/10 min, in particular between 0.4 and 5 g/10 min at 2.16 kg and 190° C.

Particular preference is given to processing by blown-film extrusion, since the carrier film can be torn with particular ease in the cross direction. In one preferred embodiment of blown-film extrusion the processing parameters are set such that the tensile strength in the longitudinal machine direction is at least twice, preferably at least four times, the tensile strength in the cross direction, the tensile strength being determined by the method of Elmendorf.

Preferred Processing Parameters are as Follows:
Longitudinal draw ratio (ratio of film winding speed to melt speed in the die) from 2 to 25, preferably from 5 to 10.
Frost line smaller than 160 cm.
The longitudinal draw ratio divided by the frost line is greater than 0.1 cm⁻¹, preferably greater than 0.2 cm⁻¹
The blow-up ratio is situated in the range from 1 to 4, preferably from 1.8 to 2.5.
The die gap is situated in the range from 1 to 1.6 mm.

The preparation of copolymers of this kind, used in accordance with the invention, is described for example in U.S. Pat. No. 3,264,272 A1.

The term “copolymer” is to be understood to the effect that it can also include two or more different α-olefins or unsaturated carboxylic acids. The unsaturated α-olefin is preferably ethylene, propylene or but-1-ene, more preferably ethylene. The unsaturated carboxylic acid may be a monocarboxylic or dicarboxylic acid such as methacrylic acid or maleic acid. The metal ions are preferably monovalent to trivalent, for example, from groups I, II, III, IV-A and VII of the Periodic Table, more preferably from the alkali metals group, particularly sodium.

Besides the copolymer of the invention, the film layer of the winding tape may include other polymers, in which case the fraction of copolymer of the invention is preferably at least 10% by weight and more preferably at least 50% by weight. In the case of two or more film layers, at least one is preferably to include this fraction.

In a further preferred embodiment, any optional blend component should not have a substantially higher melt index at 190° C. than the copolymer of the invention, but should instead preferably have a lower melt index. Suitable blend components are, for example, soft ethylene copolymers such as LDPE, LLDPE, MDPE, HDPE, metallocene-PE, EPM or EPDM, preferably with a density of 0.86 to 0.96 g/cm³. Polybut-1-ene or soft polybutene or polypropylene copolymers with a random or block structure are likewise suitable, but preferably have a crystallite melting point of less than 145° C. Ethylene-based polymers are preferred.

By blending nitrogen- or oxygen-containing polymers it is possible to reduce the flammability of olefin-containing polymers. This is also true for the winding tape of the invention. Examples of such are ethylene copolymers containing monomers which contain carbonyl groups, such as ethylene-acrylate (for example, EMA, EBA, EEA, EAA) or ethylene-vinyl acetate. Furthermore, it is claimed that polyethylene-vinyl alcohol and olefin-free nitrogen- or oxygen-containing polymers are also suitable for reducing flammability, in the form for example of polyamides and polyesters having a sufficiently low softening point (fitting in with the processing temperature of the copolymer), polyvinyl acetate, polyvinyl butyral, vinyl acetate-vinyl alcohol copolymer, and poly(meth)acrylates. Preference is given to polyvinyl acetate and soft poly(meth)acrylates, which may also have been crosslinked. They may also have a core-shell structure: for example, a core of polyacrylates of alcohols having 2 to 8 carbon atoms and a shell of polymethyl methacrylate. In particular, acrylate impact modifiers, which are prepared for the modification of PVC, prove particularly suitable, since even in small amounts they produce a marked improvement in the fire performance, while not substantially impairing the flexibility of the winding tape and, in spite of their polarity, not increasing the sticking of the melt on calender rolls or chill rolls. In one preferred embodiment the fraction of oxygen or nitrogen, based on the total weight of all polymers, is between 0.5 and 5% by weight.

In one specific embodiment the winding tape has two or more film layers, suitable coextrusion layers being the polymers stated as blend components, especially nitrogen- or oxygen-containing polymers and ethylene-based polymers. The polymer in such a coextrusion layer that is the greatest by fraction ought to have a melt index of less than 10 g/10 min, preferably less than 6 g/10 min (2.16 kg, 190° C.).

As a blend component of the copolymer of the invention or as a main constituent of a coextrusion layer, particular preference is given to ethylene-vinyl acetate and ethylene-acrylate copolymers.

The winding tape comprises, not mandatorily but preferably, a flame retardant. If wound around an insulated wire, a cable or a metallic ventilation pipe, the assembly is generally self-extinguishing, since the heat is taken off by the metal. In the case of wires or cables, and where requirements are more stringent, a flame-retarded insulation is used, and the fire performance is impaired little if at all by the winding tape of the invention. This is particularly true when nitrogen- or oxygen-containing polymers are used in the carrier film or when the winding tape comprises a flame retardant in at least one film layer or in the pressure-sensitively adhesive layer. Only halogen-free materials are suitable for this, these being, for example, fillers such as polyphosphates, carbonates and hydroxides of aluminum or of magnesium, borates, stannates, nitrogen-based flame retardants such as melamine cyanurate, dicyandiamide, red phosphorus or sterically hindered amines such as, for example, the class of the HA(L)S.

Further additives customary in the case of films, such as fillers, pigments, aging inhibitors, nucleating agents, impact modifiers or lubricants, et cetera, can be used for the production. These additives are described for example in “Kunststoff Taschenbuch”, Hanser Verlag, edited by H. Saechtling, 28th edition or “Plastic Additives Handbook”, Hanser-Verlag, edited by H. Zweifel, 5th edition. In the remarks below the respective CAS Reg. No. is used in order to avoid chemical names that are difficult to understand.

The main objective of the present invention is the absence of halogens and volatile plasticizers. As stated, the thermal requirements are going up, so that in addition an increased resistance is to be achieved with respect to conventional PVC winding tapes or the PVC-free winding tapes that are being trialed. The present invention is therefore described with reference to this in detail below.

The winding tape of the invention has a heat stability of at least 85° C., preferably 105° C. after 3000 hours, which means that after this storage there is still a breaking elongation of at least 100%. In one outstanding embodiment, using the antioxidants described below and also sufficiently high-melting coextrusion layers, it is possible to attain 125° C. after 3000 hours without embrittlement or melting. Conventional PVC winding films based on DOP have a heat stability of 85° C. (passenger compartment), while high-performance products based on polymer plasticizers attain 105° C. (engine compartment).

Furthermore, the winding tape must be compatible with polyolefin-based cable sheathing; in other words, after the cable/winding film assembly has been stored, there must be neither embrittlement of the winding tape nor of the cable insulation. Through the selection of one or more appropriate antioxidants it is possible to attain a compatibility at 105° C., preferably at 125° C. (2000 hours, in particular 3000 hours). It is, however, the aging stabilization which is decisive for attaining oxidative resistance, and this can be achieved in particular by means of secondary antioxidants such as thioesters or phosphites.

Compatibility between winding tape and the other cable-harness components, such as plugs and fluted tubes, is likewise desirable and can likewise be achieved by adapting the formulas, particularly with respect to the additives used. A negative example that may be recited is the combination of an unsuitable polypropylene winding tape with a copper-stabilized polyamide fluted tube; in this case both the fluted tube and the winding film have undergone embrittlement before reaching 3000 hours at 105° C.

In order to achieve high aging stability and compatibility with the other cable-harness components, the use of the correct aging inhibitors is assigned a particular role. In this context it is also necessary to take account of the total amount of stabilizer, since in previous experiments for the production of such winding tapes aging inhibitors were used not at all or only at below 0.3 phr, as is also usually the case for the production of other films. In the preferred embodiment the winding tapes of the invention contain more than 0.3 phr and in particular more than 1 phr of antioxidant (not including any optionally used metal deactivator). In one preferred embodiment the fraction of secondary antioxidant is more than 0.3 phr. Stabilizers for PVC products cannot be transposed to polyolefins. Secondary antioxidants break down peroxides and are therefore used as part of aging inhibitor packages in the case of diene elastomers. Surprisingly it has been found that a combination of primary antioxidants (for example, sterically hindered phenols or C-radical scavengers such as CAS 181314-48-7) and secondary antioxidants (for example, sulfur compounds, phosphites or sterically hindered amines), it also being possible for both functions to be united in one molecule, achieves the stated object in the case of diene-free polyolefins such as polypropylene as well. Particularly preferred is the combination of primary antioxidant, preferably sterically hindered phenols having a molecular weight of more than 500 g/mol (especially >700 g/mol), with a phosphitic secondary antioxidant (particularly with a molecular weight>600 g/mol). Phosphites or a combination of primary and two or more secondary aging inhibitors have not been used to date in winding tapes comprising polyolefins. The combination of a low-volatility primary phenolic antioxidant and one secondary antioxidant each from the class of the sulfur compounds (preferably with a molecular weight of more than 400 g/mol, especially >500 g/mol) and from the class of the phosphites is suitable, and in this case the phenolic, sulfur-containing and phosphitic functions need not be present in three different molecules; instead, more than one function may also be united in one molecule.

### EXAMPLES

Phenolic Function:

CAS 6683-19-8, 2082-79-3, 1709-70-2, 36443-68-2, 1709-70-2, 34137-09-2, 27676-62-6, 40601-76-1, 31851-03-3, 991-84-4

Sulfur-Containing Function:

CAS 693-36-7, 123-28-4, 16545-54-3, 2500-88-1

Phosphitic Function:

CAS 31570-04-4, 26741-53-7, 80693-00-1, 140221-14-3, 119345-01-6, 3806-34-6, 80410-33-9, 14650-60-8, 161717-32-4

Phenolic and Sulfur-Containing Function:

CAS 41484-35-9, 90-66-4, 110553-27-0, 96-96-5, 41484

Phenolic and Aminic Function:

CAS 991-84-4, 633843-89-0

Aminic Function:

CAS 52829-07-9, 411556-26-7, 129757-67-1, 71878-19-8, 65447-77-0

The combination of CAS 6683-19-8 (for example, Irganox 1010) with thiopropionic ester CAS 693-36-7 (Irganox PS 802) or 123-28-4 (irganox PS 800) and with CAS 31570-04-4 (Irgafos 168) is particularly preferred. Preference is given further to a combination in which the fraction of secondary antioxidant exceeds that of the primary antioxidant. In addition it is possible to add metal deactivators in order to complex traces of heavy metal, which may catalytically accelerate aging. Examples of appropriate metal scavengers are CAS 32687-78-8, 70331-94-1, 6629-10-3, ethylenediaminetetraacetic acid, N,N′-disalicylidene-1,2-diaminopropane or commercial products such as 3-(N-salicylol)amino-1,2,4-triazole (Palmarole ADK STAB CDA-1), N,N′-bis[3-(3′,5′-di-tert-butyl-4′-hydroxyphenyl)propionyl]hydrazide (Palmarole MDA.P.10) or 2,2′-oxamido-bis[ethyl 3-(tert-butyl-4-hydroxyphenyl)propionate] (Palmarole MDA.P.11).

The selection of the stated aging inhibitors is particularly important for the winding tape of the invention, since with phenolic antioxidants, alone or even in combination with sulfur-containing costabilizers, it is not generally possible to obtain products which conform to the art. In the case of calender processing, where on the rolls a relatively long-lasting ingress of atmospheric oxygen is unavoidable, the concomitant use of phosphite stabilizers proves virtually inevitable for sufficient thermal aging stability on the part of the product. Even in the case of extrusion processing the addition of phosphites is still manifested positively in the aging test on the product. For the phosphite stabilizer an amount of at least 0.1 phr, preferably at least 0.3 phr, is preferred. Particularly when using fillers it is possible, as a result of migratable metal impurities such as iron, manganese, chromium or copper, for aging problems to arise, which can be avoided only through abovementioned knowledge of the correct combination and amount of aging inhibitors and also of a metal deactivator.

The winding tape of the invention is preferably pigmented, especially black. Coloring may be carried out in the film layer or one of the film layers, in the adhesive layer or in any other layer. The use of organic pigments or dyes in the winding tape is possible, preference being given to the use of carbon black. The carbon black fraction is preferably at least 5 phr. As carbon black it is possible to use all of the types, such as gas black, acetylene black, furnace black and lamp black, for example, preference being given to lamp black, despite the fact that furnace blacks are usual for the coloring of films. For optimum aging, preference is given to carbon black grades having a pH in the range from 6 to 8.

The winding tape is provided on one side with a pressure-sensitive adhesive coating. The amount of the adhesive layer is in each case 10 to 40 g/m², preferably 18 to 28 g/m² (that is, the amount after removal of water or solvent, where necessary; the numerical values also correspond approximately to the thickness in μm). In one case with adhesive coating the figures given here for the thickness and for mechanical properties dependent on thickness refer exclusively to the copolymer-containing layer of the winding tape, without taking into account the adhesive layer or other layers which are advantageous in connection with adhesive layers. The coating need not cover the whole area, but may also be configured for partial coverage. An example that may be mentioned is a winding tape with a pressure-sensitively adhesive strip at each of the side edges. This strip can be cut off to form approximately rectangular sheets, which are adhered to the cable bundle by one adhesive strip and are then wound until the other adhesive strip can be bonded to the reverse of the winding tape. A hoselike envelope of this kind, similar to a sleeve form of packaging, has the advantage that there is virtually no reduction in the flexibility of the cable harness as a result of the wrapping.

Suitable adhesives include all customary types, especially those based on rubber. Rubbers of this kind may be, for example, homopolymers or copolymers of isobutylene, of 1-butene, of vinyl acetate, of ethylene, of acrylic esters, of butadiene or of isoprene. Particularly suitable formulas are those based on polymers which are themselves based on acrylic esters, vinyl acetate or isoprene.

In order to optimize the properties it is possible for the self-adhesive mass employed to have been blended with one or more additives such as tackifiers (resins), plasticizers, fillers, flame retardants, pigments, UV absorbers, light stabilizers, aging inhibitors, photoinitiators, crosslinking agents or crosslinking promoters. Tackifiers are, for example, hydrocarbon resins (for example, polymers based on unsaturated C5 or C9 monomers), terpene-phenolic resins, polyterpene resins formed from raw materials such as α- or β-pinene, for example, aromatic resins such as coumarone-indene resins, or resins based on styrene or α-methylsytrene, such as rosin and its derivatives, disproportionated, dimerized or esterified rosin, for example, such as reaction products with glycol, glycerol or pentaerythritol, for example, to name only a few, and also further resins (as recited, for example, in Ullmanns Enzylopädie der technischen Chemie, Volume 12, pages 525 to 555 (4th ed.), Weinheim). Preference is given to resins without easily oxidizable double bonds, such as terpene-phenolic resins, aromatic resins, and, with particular preference, resins prepared by hydrogenation, such as, for example, hydrogenated aromatic resins, hydrogenated polycyclopentadiene resins, hydrogenated rosin derivatives or hydrogenated terpene resins.

Examples of suitable fillers and pigments include carbon black, titanium dioxide, calcium carbonate, zinc carbonate, zinc oxide, silicates or silica. Suitable admixable plasticizers are, for example, aliphatic, cycloaliphatic and aromatic mineral oils, diesters or polyesters of phthalic acid, trimellitic acid or adipic acid, liquid rubbers (for example, nitrile rubbers or polyisoprene rubbers of low molecular mass), liquid polymers of butene and/or isobutene, acrylic esters, polyvinyl ethers, liquid resins and soft resins based on the raw materials of tackifier resins, lanolin and other waxes or liquid silicones. Examples of crosslinking agents include isocyanates, phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acid. Examples of aging inhibitors include sterically hindered phenols, which are known, for example, under the trade name Irganox™.

Suitable flame retardants include only halogen-free materials, including for example fillers such as polyphosphates, carbonates and hydroxides of aluminum or of magnesium, borates, stannates, nitrogen-based flame retardants such as melamine cyanurate, dicyandiamide, red phosphorus or sterically hindered amines such as, for example, the class of the HA(L)S.

Crosslinking is advantageous, since the shear strength (expressed as holding power, for example) is increased and hence the tendency toward deformation in the rolls on storage (telescoping or formation of cavities, also called gaps) is reduced. Exudation of the pressure-sensitive adhesive mass is reduced as well. This is manifested in tack-free side edges of the rolls and tack-free edges in the case of the winding tape wound spirally around the cable. The holding power is preferably more than 150 min.

The bond strength to steel ought to be situated in the range from 1.5 to 3 N/cm and, on the reverse of the winding tape, in the range from 1.0 to 2.5 N/cm.

In summary the preferred embodiment has on one side a solvent-free self-adhesive mass which has been obtained by coextrusion, melt coating or dispersion coating. Dispersion adhesives are preferred, especially polyacrylate-based ones.

Advantageous is the use of a primer layer between winding tape and adhesive mass in order to improve the adhesion of the adhesive mass on the winding tape and hence to prevent transfer of adhesive to the reverse of the film during unwinding of the rolls.

Primers which can be used are the known dispersion- and solvent-based systems based for example on isoprene or butadiene rubbers and/or cyclo rubbers. Isocyanate or epoxy resin additives improve the adhesion and in part also increase the shear strength of the pressure-sensitive adhesive. Physical surface treatments such as flaming, corona or plasma, or coextrusion layers, are likewise suitable for improving the adhesion. Particular preference is given to utilizing such methods when using solvent-free adhesive layers, especially those based on acrylate.

The reverse face can be coated with known release agents (blended where appropriate with other polymers). Examples are stearyl compounds (for example, polyvinyl stearylcarbamate, stearyl compounds of transition metals such as Cr or Zr, and ureas formed from polyethyleneimine and stearyl isocyanate), polysiloxanes (for example, as a copolymer with polyurethanes or as a graft copolymer on polyolefin), and thermoplastic fluoropolymers. The term stearyl stands as a synonym for all linear or branched alkyls or alkenyls having a C number of at least 10, such as octadecyl, for example.

Descriptions of the customary adhesive masses and also reverse-face coatings and primers are found for example in “Handbook of Pressure Sensitive Adhesive Technology”, D. Satas, (3rd edition). The stated reverse-face primer coatings and adhesive coatings are possible in one embodiment by means of coextrusion.

The configuration of the reverse face of the film may also, however, serve to increase the adhesion of the adhesive mass to the reverse face of the winding tape (in order to control the unwind force, for example). In the case of polar adhesives such as those based on acrylate polymers, for example, the adhesion of the reverse face to a film based on olefin-containing polymers is often not sufficient. For the purpose of increasing the unwind force an embodiment is claimed in which the polar reverse-face surfaces are achieved by corona treatment, flame pretreatment or coating/coextrusion with polar raw materials.

Claimed alternatively is a winding tape in which the log product has been conditioned (stored under hot conditions) prior to slitting. Both processes may also be employed in combination. The winding tape of the invention preferably has an unwind force of 1.2 to 6.0 N/cm, very preferably of 1.6 to 4.0 N/cm, and in particular of 1.8 to 2.5 N/cm, at an unwind speed of 300 mm/min. The conditioning is known in the case of PVC winding tapes, but for a different reason. In contradistinction to partially crystalline polyolefin copolymer films, plasticized PVC films have a broad softening range and, since the adhesive mass has a lower shear strength, owing to the migrated plasticizer, PVC winding tapes tend toward telescoping. This disadvantageous deformation of the rolls, in which the core is forced out of the rolls to the side, can be prevented if the material is stored for a relatively long time prior to slitting or is subjected briefly to conditioning (storage under hot conditions for a limited time). In the case of the process of the invention, however, the purpose of the conditioning is to increase the unwind force of film material with an olefin-containing reverse face and with a polar adhesive mass, such as polyacrylate or EVA, since this adhesive mass exhibits extremely low reverse-face adhesion to olefin-containing material in comparison to PVC. An increase in the unwind force by conditioning or physical surface treatment is unnecessary with plasticized PVC winding tapes, since the adhesive masses normally used possess sufficiently high adhesion to the polar PVC surface. In the case of polyolefin winding tapes the significance of reverse-face adhesion is particularly pronounced, since because of the higher force at 1% elongation (owing to the absence of the plasticizer) a much higher reverse-face adhesion, and unwind force, is necessary, in comparison to PVC films, in order to provide sufficient stretch during unwind for the application. The preferred embodiment of the winding tape is therefore produced by conditioning or physical surface treatment in order to achieve outstanding unwind force and stretch during unwind, the unwind force at 300 mm/min being higher preferably by at least 50% than without such a measure.

In the case of an adhesive coating, the winding tape of the invention is preferably stored beforehand for at least 3 days, more preferably at least 7 days, prior to coating, in order to achieve post-crystallization, so that the rolls do not acquire any tendency toward telescoping (probably because the film contracts on crystallization). Preferably the film on the coating installation is guided over heated rollers for the purpose of leveling (improving the flat lie), which is not customary for PVC winding tapes.

Normally, polyolefin-material films cannot be torn into or torn off by hand. As partially crystalline materials, they can be stretched with ease and therefore have a high breaking elongation, generally of well above 500%.

When attempts are made to tear such films what occurs, rather than clean tearing, is film stretching. Even high forces may not necessarily overcome the typically high rupture forces. Even if tearing is successful, the tear which is produced does not look good and cannot be used for bonding, since a thin, narrow “tail” is formed at either end of the parted film. Nor can this problem be eliminated by means of additives, even if large amounts of fillers reduce the breaking elongation. If polyolefin films are biaxially stretched the breaking elongation is reduced by more than 50%, to the benefit of tearability. Attempts to transfer this process to soft winding tapes fail, however, since there is a considerable increase in the 1% force value and the force/elongation curve becomes considerably steeper. A consequence of this is that the flexibility and conformability of the winding tape are drastically impaired. The winding tape of the invention, however, exhibits very good behavior when torn in the machine direction or torn into in the cross direction. Additionally it is possible to optimize the tear behavior by means of the slitting process when converting the rolls. In the course of production of rolls of winding tape, rough slit edges can be produced which, viewed microscopically, form cracks in the film, which then evidently promote tear propagation. This is possible in particular through the use of a crush slitting with blunt rotating knives, or rotating knives with a defined sawtooth, on product in bale form (jumbo rolls, high-length rolls) or by means of a parting slitting with fixed blades or rotating knives on product in log form (rolls in production width and conventional selling length). The breaking elongation can be adjusted by appropriate grinding of the blades and knives. Preference is given to the production of log product with parting slitting using blunt fixed blades. By cooling the log rolls sharply prior to slitting it is possible to improve still further the formation of cracks during the slitting operation. In the preferred embodiment the breaking elongation of the specially slit winding tape is lower by at least 30% than when it is slit with sharp blades. In the particularly preferred embodiment of the winding tape whose side edges are subjected to defined damage in the course of slitting, the breaking elongation is between 200% and 400%. In order to increase the unwind force, the log product can be subjected to storage under hot conditions beforehand. Conventional winding tapes with cloth, web or film carriers (PVC for example) are slit by shearing (between two rotating knives), parting (fixed or rotating knives are pressed into a rotating log roll of the product), blades (the web is divided in the course of passage through sharp blades) or crushing (between a rotating knife and a roller).

The purpose of slitting PVC winding tapes is only to produce saleable rolls from jumbo or log rolls, but not to produce rough slit edges for the purpose of easier hand tearability. In the case of PVC winding tapes the parting slit is entirely conventional, since the process is economic in the case of soft films. In the case of PVC material, however, hand tearability is very good, since, unlike olefin polymers, PVC is amorphous and therefore is not stretched on tearing, only elongated a little. So that the PVC films do not tear too easily, attention must be paid to sufficient gelling in the course of production of the film, which goes against an optimum production speed. In many cases, therefore, instead of standard PVC with a K value of 63 to 65, material of higher molecular weight is used, corresponding to K values of 70 or more. With the copolymer winding tapes of the invention, therefore, the reason for the parting slit is different than in the case of those made of PVC.

The concept of the invention hence also embraces an easy-tear halogen-free winding tape composed of a film comprising a copolymer of
(a) c-olefin of the formula R—CH═CH₂, where R is hydrogen or an alkyl radical having 1 to 10 carbon atoms, and
(b) an α,β-ethylenically unsaturated carboxylic acid of 3 to 8 carbon atoms, and
(c) optionally a further monoethylenically unsaturated monomer, 10 to 90% of the carboxylic acid groups of the copolymer being ionized as a result of neutralization with metal compounds.

When the winding tape is used it is preferably fixed with an adhesive tape at the end of winding.

The winding tape of the invention is outstandingly suitable for the wrapping of elongate material such as field coils or cable looms in vehicles. The winding tape of the invention is likewise suitable for other applications, such as, for example, for ventilation pipes in an air-conditioning installation, since the high flexibility ensures good conformability to rivets, beads and folds. Present-day occupational hygiene and environmental requirements are met, because halogenated raw materials are not used; the same also applies to volatile plasticizers, except where the amounts are so small that the fogging number is generally not below 90%. Absence of halogen is extremely important for the recovery of heat from wastes which include such winding tapes (for example, incineration of the plastics fraction from vehicle recycling). The product of the invention is halogen-free in the sense that the halogen content of the raw materials is so low that it plays no part in the flame retardancy. Halogens in trace amounts, such as may occur as a result of impurities or as residues of catalysts (from the polymerization of the polymers used, for example), remain disregarded. The omission of halogens is accompanied by the quality of easy flammability, which is not in accordance with the safety requirements in electrical applications such as household appliances or vehicles. The problem of deficient flexibility when using customary PVC substitute materials such as polypropylene, polyesters, polystyrene, polyamide or polyimide for the winding tape is solved in the underlying invention not by means of volatile plasticizers but instead by the use of a specific soft copolymer, which in spite of its softness and flexibility allows good tearability, particularly when the optimum operating conditions outlined are employed. The flexibility is of outstanding importance, since application to wires and cables requires not only spiral winding but also creaseless curve-flexible winding at branching points, plugs or fastening clips. Moreover, it is desirable for the winding tape to draw the cable strand together elastically. This behavior is also needed for the sealing of ventilation pipes. These mechanical properties can be achieved by a flexible winding tape based on the copolymer of the invention.

Test Methods

The measurements are carried out under test conditions of 23±1° C. and 50 ±5% relative humidity.

The density of the polymers is determined in accordance with ISO 1183 and the flexural modulus in accordance with ISO 178 and expressed in g/cm³ and MPa respectively. The flexural modulus in accordance with ASTM D790 is based on different specimen dimensions, but the result is comparable as a number. The melt index is tested in accordance with ISO 1133 and expressed in g/10 min. The test conditions are, as is the market standard, 230° C. and 2.16 kg for polymers containing crystalline polypropylene and 190° C. and 2.16 kg for polymers containing crystalline polyethylene. The crystallite melting point (T_{cr}) is determined by DSC in accordance with MTM 15902 (Basell method) or ISO 3146.

The tensile elongation behavior of the winding tape is determined on type 2 test specimens (rectangular test strips 150 mm long and, as far as possible, 15 mm wide) in accordance with DIN EN ISO 527-3/2/300 with a test speed of 300 mm/min, a clamped length of 100 mm and a pretensioning force of 0.3 N/cm. In the case of specimens with rough slit edges, the edges should be tidied up with a sharp blade prior to the tensile test. In deviation from this, for determining the force or tension at 1% elongation, measurement is carried out with a test speed of 10 mm/min and a pretensioning force of 0.5 N/cm on a model Z 010 tensile testing machine (manufacturer: Zwick). The testing machine is specified since the 1% value may be influenced somewhat by the evaluation program. Unless otherwise indicated, the tensile elongation behavior is tested in machine direction (MD). The force is expressed in N/strip width and the tension in N/strip cross section, the breaking elongation in %. The test results, particularly the breaking elongation (elongation at break), must be statistically ascertained by means of a sufficient number of measurements.

The bond strengths are determined at a peel angle of 180° in accordance with AFERA 4001 on test strips which (as far as possible) are 15 mm wide. AFERA standard steel plates are used as the test substrate, in the absence of any other substrate being specified.

The thickness of the winding tape's film layer is determined in accordance with DIN 53370 (the pressure-sensitive adhesive layer is disregarded).

The holding power is determined in accordance with PSTC 107 (10/2001), the weight being 20 N and the dimensions of the bond area being 20 mm in height and 13 mm in width.

The unwind force is measured at 300 mm/min in accordance with DIN EN 1944.

The hand tearability is hard to express in numbers, although breaking force, breaking elongation and impact strength under tension (all measured in machine direction) are of substantial influence. The film is torn through crosswise, between two pairs of thumbs and index-fingertips, and also, after the end of a winding operation, is torn sharply in machine direction.

Evaluation:

+++=very easy,

++=good,

+=still processable,

−=difficult to process,

−−=can be torn only with high application of force; the ends are untidy,

−−−=unprocessable

The tensile strength is tested by the method of Elmendorf in accordance with ASTM D1922. As the criterion for a cleanly transversely running tear the ratio of cross-direction tensile strength to machine-direction tensile strength is employed.

The heat stability is determined by a method based on ISO/DIN 6722. The oven is operated in accordance with ASTM D 2436-1985 with 175 air changes per hour. The test time amounts to 3000 hours. The test temperature chosen is 105° C. (similar to class B but 105° C. rather than 100° C.).

In the case of compatibility testing, storage under hot conditions is carried out on commercially customary leads (cables) with polyolefin insulation (polypropylene or radiation-crosslinked polyethylene) for motor vehicles. For this purpose, specimens are produced from, leads with a cross section of 3 to 6 mm² a length of 350 mm and total diameter of 10 mm, with winding tape by wrapping with a 50% overlap. After the aging of the specimens in a forced-air oven for 3000 hours (conditions as for heat stability testing), the samples are conditioned at 23° C. and in accordance with ISO/DIN 6722 are wound by hand around a mandrel. The winding mandrel has a diameter of 5 mm, the weight has a mass of 5 kg, and the winding rate is 1 rotation per second. The specimens are subsequently inspected for defects in the winding tape and in the wire insulation beneath the winding tape. The test is failed if cracks can be seen in the wire insulation, particularly if this is apparent even before bending on the winding mandrel. If the winding film has cracks or has melted in the oven, the test is likewise classed as failed. In the case of the 125° C. test, specimens were in some cases also tested at different times. The test time is 3000 hours unless expressly described otherwise in an individual case.

In the case of the low-temperature test at the above-described specimen is cooled to −40° C. for 4 hours, in a method based on ISO/DIS 6722, and the sample is wound by hand onto a mandrel with a diameter of 5 mm. The specimens are examined visually for defects (cracks) in the adhesive tape.

The breakdown voltage is measured in accordance with ASTM D 1000. The number taken is the highest value for which the specimen withstands this voltage for one minute. This number is converted to a sample thickness of 100 μm.

### EXAMPLE

A sample 200 μm thick withstands a maximum voltage of 6 kV for one minute: the calculated breakdown voltage amounts to 3 kV/100 μm.

The fogging number is determined in accordance with DIN 75201 A.

The fire performance is tested in accordance with a method from an automaker. For this purpose the test wires with a lead cross section of approximately 0.5 mm and with polyolefin insulation are processed to a cable harness 30 cm long and 10 mm in diameter by wrapping with the winding tape under test. The degree of overlap of the winding tape amounts to 50%. The cable harness is fixed horizontally and heated to ignition for 30 seconds with a gas flame which is 130 mm long and includes an inner flame 35 mm long. The tip of the deoxidizing flame is directed from below onto the center of the sample. The test is passed if the cable harness extinguishes itself within the draft-free room.

The whitening is determined visually on a sample 100 mm long which has been stretched 300 mm/min to 200% of its original length on a tensile testing machine.

The examples which follow are intended to illustrate the invention without restricting its scope.

Contents:

Description of the inventive examples

Tabular compilation of the results of the inventive examples

Description of the comparative examples

Tabular compilation of the results of the comparative examples

### Example 1

To produce the carrier film an ethylene copolymer with Na ions (Surlin 1601-2, DuPont) was extruded as a flat film (=casting process) with a die temperature of 200° C. The resulting film is corona-treated on one side and then to that side the adhesive Rikidyne BDF 505 (with addition of 1% by weight of Desmodur Z 4470 MPA/X per 100 parts by weight of adhesive, calculated on the basis of solids content) is applied at 23 g/m². The pressure-sensitive adhesive is dried in a hot tunnel, in the course of which it undergoes chemical crosslinking, and at the end of the dryer is then wound into log rolls having a running length at 25 m. Slitting is performed by parting the resultant logs by means of rotating knives (round blade), to give rolls with a width of 15 mm.

Winding tape properties

Holding power >2000 min (measurement then discontinued)

The product is easy to tear off and tear into by hand, with the crack propagating in no preferential direction. After storage at 120° C. for 7 days the sample has undergone neither embrittlement nor melting.

### Example 2

A film is produced on a film-blowing line. The outer layers are composed of

| | | |
|---|---|---|
| 74% | by weight | LDPE (LD 166 BA, ExxonMobil), |
| 20% | by weight | HDPE (HMA 035, ExxonMobil), |
| 1% | by weight | antioxidant mixture (consisting of ¼ Irganox 1010, |
| | | ½ Irganox PS 802, ¼ Irgafos 168) and |
| 5% | by weight | carbon black batch (Plasblack PE 1851, Cabot) |

and the middle layer of

| | | |
|---|---|---|
| 99% | by weight | ethylene copolymer with Na ions (Surlin 1601-2, |
| | | DuPont) and |
| 1% | by weight | abovementioned antioxidant mixture. |

Process Conditions:

Extruder temperature 175° C.

Die temperature 180° C.

Blow-up ratio 2.6

Longitudinal draw ratio 5.8

Frost line height 60 m

Outer layer thickness each 40 μm

Middle layer thickness 35 μm

The carrier film thus produced is subjected to a single-side flame pretreatment and is coated with Acronal DS 3458 (pressure-sensitive acrylate hotmelt adhesive) by means of a roll applicator at 50 m/min. The temperature load on the carrier is reduced by means of a cooled counterpressure roller. The adhesive application rate is approximately 35 g/m². Appropriate crosslinking of the pressure-sensitive adhesive is achieved in line, prior to winding, by irradiation with a UV unit equipped with 6 medium-pressure Hg lamps each of 120 W/cm. The irradiated web is wound up to form log rolls with a running length of 20 m on 1¼-inch (31 mm) cores. For the purpose of increasing the unwind force, the logs are conditioned by heat treatment in an oven at 60° C. for 5 hours. Slitting is performed by parting the logs using a fixed blade (straight knife) to give rolls 50 mm wide. This winding tape features a relatively low crosswise tensile strength by the method of Elmendorf (14 N/mm, 30 N/mm in machine direction) and in spite of the high width can be torn off with clean edges.

### Example 3

A film is produced on a blown-film line. One layer is 40 μm thick and is composed of a compound of

| | | |
|---|---|---|
| 78.7% | by weight | ethylene copolymer with Zn ions |
| | | [Novex M21G764, BP], |
| 0.3% | by weight | Irganox 1010, |
| 1% | by weight | Irganox PS 802 |
| 20% | by weight | melamine cyanurate [Melapur NC25, |
| | | Nordmann-Rassmann], |

the other is 60 μm thick and is composed of

| | | |
|---|---|---|
| 85% | by weight | EVA (LD 36, ExxonMobil), |
| 5% | by weight | carbon black batch (Plasblack PE 1851, Cabot), |
| 5% | by weight | matting agent batch (LCC 70, Schulman) and |
| 5% | by weight | antioxidant masterbatch (TS 801 LD, Polyplast Müller) |

Following corona treatment on the uncolored side, an aqueous acrylate pressure-sensitive adhesive (90 parts by weight in supply form Primal PS 83 D and 10 parts by weight melamine cyanurate) is applied by means of a barcoater with an application rate of 24 g/m². The adhesive layer is dried in a drying tunnel at 70° C. and the finished winding tape is wound up into log rolls with a running length of 20 m on 1-inch (25 mm) cores. Slitting is accomplished by parting the log rolls using a fixed blade with a not very pointed angle (straight knife), to give rolls 19 mm wide.

This winding film exhibits a slightly matt surface.

### Example 4

In a film-blowing process a film is produced from 65% by weight of an ethylene copolymer with Li ions (Surlin 7930, DuPont), 30% by weight of an Eva (LD261, Exxon-Mobil) and 5% by weight of an antioxidant masterbatch (PPM 1553, Polyplast Muller). The corona-treated side is coated with an adhesion promoter layer comprising natural rubber, cyclo rubber and 4,4′-diisocyanatodiphenylmethane (solvent: toluene) of 0.6 g/m², and dried. The coating of adhesive is applied directly to the adhesion promoter layer by means of a comma bar at an application rate of 18 g/m² (based on solids content). The adhesive is composed of a solution of a natural rubber adhesive in n-hexane with a solids content of 30 percent by weight. This adhesive is composed of

| | | |
|---|---|---|
| 50 | parts | natural rubber, |
| 10 | parts | zinc oxide, |
| 3 | parts | rosin, |
| 6 | parts | alkylphenol resin, |
| 17 | parts | terpene phenolic resin, |
| 12 | parts | poly-β-pinene resin, |
| 1 | part | antioxidant Irganox 1076 and |
| 2 | parts | mineral oil. |

The second coat is dried in a drying tunnel at 100° C. Immediately downstream of this, the film is slit in a composite automatic slitter featuring a knife bar with sharp blades at a distance of 19 mm to form rolls on standard adhesive tape cores (3 inch).

### Example 5

On a blown-film line a film of adhesive layer is used, the formula being as follows:

Layer 1:

60 μm:

| | | |
|---|---|---|
| 70% | by weight | LDPE (LD 166 BA, ExxonMobil), |
| 20% | by weight | HDPE (HMA 035, ExxonMobil), |
| 5% | by weight | antioxidant masterbatch (PPM 1553, |
| | | Polyplast Müller) and |
| 5% | by weight | carbon black batch (Plasblack PE 1851, Cabot) |

Layer 2:

60 μm:

| | | |
|---|---|---|
| 95% | by weight | ethylene copolymer with Na ions |
| | | (Surlin 1601-2, DuPont) and |
| 5% | by weight | antioxidant masterbatch (PPM 1553, |
| | | Polyplast Müller) |

Layer 3:

15 μm:

100 phr Escorene UL 02133

Layer 4:

20 μm: Levapren 450

The adhesive film is corona-treated on the reverse with low power, in line, and is wound into logs with a running length of 20 m which are conditioned by heat treatment at 40° C. for one week. Slitting is accomplished by parting the logs using a fixed blade (straight knife). As a result of the conditioning the unwind force increases to such an extent that the winding film can be applied under gentle tension. This embodiment is solvent-free and is easy to prepare since no coating operation is necessary.

The ratio of the machine- to cross-direction tensile strengths is 7.2.

Properties of the inventive examples

| | Example | Example | Example | Example | Example |
|---|---|---|---|---|---|
| | 1 | 2 | 3 | 4 | 5 |
| Film thickness [mm] | 0.1 | 0.115 | 0.1 | 0.12 | 0.135 |
| Bond strength steel [N/cm] | 2.4 | 3.0 | 2.9 | 3.0 | 1.9 |
| Bond strength to own reverse [N/cm] | 1.9 | 2.2 | 1.9 | 18 | 1.7 |
| Unwind force [N/cm] | 2.2 | 2.4 | 2.2 | 2.7 | 2.6 |
| Tensile strength* [N/cm] | 10 | 22 | 7 | 26 | 33 |
| Breaking elongation* [%] | 350 | 320 | 190 | 290 | 330 |
| Force at 1% elongation [N/cm] | 1.0 | 2.5 | 1.9 | 0.5 | 1.7 |
| Force at 100% elongation [N/cm] | 7 | 15 | 4 | 19 | 21 |
| Breaking elongation* after 3000 h @ | yes | yes | yes | yes | yes |
| 105° C. > 100% | | | | | |
| Compatibility with PE and PP cables | no | no | no | no | no |
| 3000 h @ 105° C. | embrittle- | embrittle- | embrittle- | embrittle- | embrittle- |
| | ment | ment | ment | ment | ment |
| Hand tearability | +++ | ++ | ++ | + | +++ |
| Breakdown voltage [kV/100 μm] | 10 | 11 | 5 | 9 | 12 |
| Fogging number | 98 | 96 | 99 | 55 | 93 |
| Absence of halogen | yes | yes | yes | yes | yes |
| Fire test on PE and PP cables | OK | OK | OK | OK | OK |
| Low-temperature test, −40° C. | OK | OK | OK | OK | OK |
| Whitening | no | no | yes | no | no |

*on specimens slit using blades

### Comparative Example 1

Coating is carried out using a conventional film for insulating tape, from Singapore Plastic Products Pte, under the name F2104S. According to the manufacturer the film contains

| about 100 | phr | suspension PVC with a K value of 63 to 65, |
|---|---|---|
| 43 | phr | DOP (di-2-ethylhexyl phthalate), |
| 5 | phr | tribasic lead sulfate (TLB, stabilizer), |
| 25 | phr | ground chalk (Bukit Batu Murah Malaysia |
| | | with fatty acid coating), |
| 1 | phr | furnace black and |
| 0.3 | phr | stearic acid (lubricant). |

phr corresponds to parts per hundred resin.

The nominal thickness is 100 μm and the surface is smooth but matt.

Applied to one side is the primer Y01 from Four Pillars Enterprise, Taiwan (analytically acrylate-modified SBR rubber in toluene) and atop that 23 g/m² of the adhesive IV9 from Four Pillars Enterprise, Taiwan (analytically determinable main component: SBR and natural rubber, terpene resin and alkylphenol resin in toluene). Immediately downstream of the dryer, the film is slit into rolls in an automatic composite slitter having a knife bar with sharp blades at a distance of 25 mm.

The breaking elongation after 3000 h at 105° C. cannot be measured, since as a result of plasticizer evaporation the specimen has disintegrated into small pieces. After 3000 h at 85° C. the breaking elongation is 150%.

### Comparative Example 2

Example A of WO 97/05206 A1 is reworked.

The production of the compound is not described. The components are therefore mixed on a twin-screw laboratory extruder with a length of 50 cm and an L/D ratio of 1:10:

| | | |
|---|---|---|
| 9.59 | phr | Evatane 2805, |
| 8.3 | phr | Attane SL 4100, 82.28 phr Evatane 1005 VN4, |
| 74.3 | phr | Martinal 99200-08, |
| 1.27 | phr | Irganox 1010, |
| 0.71 | phr | AMEO T, 3.75 black masterbatch (prepared from 50% by |
| | | weight each of polyethylene with MFI = 50 and |
| | | Furnace Seast 3 H), |
| 0.6 | phr | stearic acid and |
| 0.60 | phr | Luwax AL 3. |

The compound is granulated, dried and blown on a laboratory line to form a film bubble, which is slit on both sides. An attempt is made to coat the film with adhesive after corona pretreatment, as in example 1; however, the film exhibits excessive contraction in the cross and machine directions, and because of excessive unwind force it is hardly still possible to unwind the rolls after 4 weeks.

This is therefore followed by an experiment for coating with an apolar rubber adhesive as in example 6, but this attempt fails because of the sensitivity of the film to solvent. Since the publication indicated does not describe coating with adhesive, but does describe adhesive properties that are to be aimed at, the film is slit up with shears between a set of pairs of two rotating knives each, to give strips 25 mm wide, which are wound.

The self-adhesive winding tape features good flexibility and flame retardancy. The hand tearability, however, is inadequate. Moreover, the winding tape results in a considerable shortening of the lifetime of the cable insulation, as a result of embrittlement. The high contraction tendency is caused by the inadequate melt index of the compound. Even with a higher melt index of the raw materials, problems are likely, despite the fact that the contraction will become much lower as a result, since no heat-setting is envisaged in the stated publication, despite the low softening point of the film. Since the product exhibits no significant unwind force it is almost impossible to apply to wire bundles. The fogging number is 73% (probably owing to the paraffin wax).

### Comparative Example 3

Example 1 of EP 0 953 599 A1 is reworked.

The preparation of the compound is mixed as described on a single-screw laboratory extruder:

| | | |
|---|---|---|
| 85 | phr | Lupolex 18 E FA, |
| 6 | phr | Escorene UL 00112, |
| 9 | phr | Tuftec M-1943, |
| 63 | phr | Magnifin H 5, |
| 1.5 | phr | magnesium stearate, |
| 11 | phr | Novaexcel F 5, |
| 4 | phr | Seast 3 H, |
| 0.2 | phr | Irganox 1010 and |
| 0.2 | phr | Tinuvin 622 LD, a marked release of phosphine |
| | | being apparent from its odor. |

Film preparation takes place on a laboratory film-blowing line.

The film, however, has a large number of specks of filler and has small holes, and the bubble tears a number of times during the experiment. The breakdown voltage varies widely from 0 to 3 kV/100μ. For further homogenization, therefore, the granules are melted again in the extruder and granulated. The compound now obtained has only a small number of specks. Coating and slitting take place as in example 1.

Through the use of red phosphorus, the self-adhesive winding tape features very good flame retardancy. Since the product has no unwind force, it is virtually impossible to apply to wire bundles. The heat stability is inadequate, owing to the low melting point.

### Comparative Example 4

A UV-crosslinkable acrylate hotmelt adhesive of the type Acronal DS 3458 is applied by means of nozzle coating at 50 m/min to a textile carrier of the Maliwatt stitchbonded knit filament web type (80 g/m², 22 denier, black, thickness about 0.3 mm). The temperature load on the carrier is reduced by means of a cooled counterpressure roll. The application rate is about 65 g/m². Appropriate crosslinking is achieved in line, upstream of the winding process, by irradiation with a UV unit equipped with 6 medium-pressure Hg lamps each of 120 W/cm. The bales are converted by shearing slitting (between a set of rotating blades slightly offset in pairs) to give rolls on standard 3-inch cores.

This winding tape features good adhesive properties and also very good compatibility with different cable insulation materials (PVC, PE, PP) and fluted tubes. From a performance standpoint, however, the high thickness and the absence of hand tearability are very disadvantageous.

### Comparative Example 5

Example 1 of WO 00/71634 A1 is reworked.

The following mixture is produced in a compounder:

| | | |
|---|---|---|
| 80.8 | phr | ESI DE 200, |
| 19.2 | phr | Adflex KS 359 P, |
| 30.4 | phr | calcium carbonate masterbatch SH3, |
| 4.9 | phr | Petrothen PM 92049, |
| 8.8 | phr | antimony oxide TMS and |
| 17.6 | phr | DE 83-R. |

The compound is processed to flat film on a laboratory casting line, corona-pretreated, coated at 20 g/m² with JB 720, wound into log rolls with a 3-inch core, and slit by parting with a fixed blade (advanced by hand).

This winding tape features PVC-like mechanical behavior: that is, high flexibility and good hand tearability. A disadvantage is the use of brominated flame retardants. Moreover, the heat distortion resistance at temperatures above 95° C. is low, so that the film melts during the aging and compatibility tests.

| Properties of the comparative | Comp. | Comp. | Comp. | Comp. | Comp. |
|---|---|---|---|---|---|
| examples | Ex. 1 | Ex. 2 | Ex. 3 | Ex. 4 | Ex. 5 |
| Film thickness [mm] | 0.08 | 0.15 | 0.20 | 0.29 | 0.125 |
| Bond strength steel [N/cm] | 1.8 | 2.0 | 1.9 | 5.1 | 2.3 |
| Bond strength to own reverse [N/cm] | 1.6 | 1.8 | 1.4 | 1.5 | 1.2 |
| Unwind force [N/cm] | 2.0 | 1.9 | 1.7 | 3.5 | 1.5 |
| Tensile strength* [N/cm] | 15 | 22.3 | 44.0 | 51.3 | 22.5 |
| Breaking elongation* [%] | 150 | 92 | 720 | 72 | 550 |
| Force at 1% elongation [N/cm] | 1.0 | 4.3 | 5.9 | 5.2 | 0.46 |
| Force at 100% elongation [N/cm] | 14.0 | − | 19.8 | − | 6.3 |
| Breaking elongation* after 3000 h @ | embrittled | yes | yes | no | embrittled |
| 105° C. > 100% | | | | embrittle- | |
| | | | | ment | |
| Compatibility with PE and PP cables | no | cable | tape | yes | tape |
| 3000 h @ 105° C. | | embrittled | fragile | | fragile |
| Hand tearability | +++ | − | − | − | + |
| Breakdown voltage [kV/100 μm] | 4 | 3 | 3 | 2 | 4 |
| Fogging number | 29 | 73 | 63 | 99 | 73 |
| Absence of halogen | no | yes | yes | yes | no |
| Fire test on PE and PP cables | OK | OK | OK | OK | OK |
| Low-temperature test, −40° C. | Not OK | OK | OK | OK | Not OK |
| Whitening | no | yes | yes | no | yes |

*on specimens slit using blades

1. An easy-tear, halogen-free winding tape composed of a film layer and of an adhesive layer, the film comprising a copolymer of
(a) α-olefin of the formula R—CH═CH₂, where R is hydrogen or an alkyl radical having 1 to 10 carbon atoms, and
(b) an α,β-ethylenically unsaturated carboxylic acid of 3 to 8 carbon atoms, and
(c) optionally a further monoethylenically unsaturated monomer, 10 to 90% of the hydrogen atoms of the carboxylic acid groups of the copolymer being substituted by metal ions as a result of neutralization.

2. The winding tape of claim 1, wherein the metal ions of the copolymer are monovalent to trivalent and comes optionally from groups I, II, III, IV-A and VII of the Periodic Table.

3. The winding tape of claim 1, wherein the fraction of copolymer at least 10% by weight.

4. The winding tape of claim 1, wherein the film layer is produced by blown-film extrusion.

5. The winding tape of claim 1, wherein
the longitudinal draw ratio (ratio of film winding speed to melt speed in the die) is 2 to 25,
the frost line is smaller than 160 cm,
the longitudinal draw ratio divided by the frost line is greater than 0.1 cm⁻¹,
the blow-up ratio is situated in the range from 1 to 4, and/or
the die gap is situated in the range from 1 to 1.6 mm.

6. The winding tape of claim 1, wherein the tensile strength as determined by the method of Elmendorf in the machine direction is at least twice the tensile strength in the cross direction.

7. The winding tape of claim 1, wherein
film layer thickness is from 30 to 180 μm,
force at 1% elongation in machine direction is 0.6 to 4 N/cm,
force at 100% elongation is from 5 to 20 N/cm,
breaking elongation is 200 to 1000%,
tensile strength is 6 to 40, and/or
breakdown voltage is at least 5 kV/100 μm.

8. The winding tape of claim 1, wherein there is a primer layer between film layer and adhesive layer,
the amount of the adhesive layer is 10 to 40 g/m²,
the bond strength to steel is 1.5 to 3 N/cm,
the unwind force is 1.2 to 6.0 N/cm at an unwind speed of 300 mm/min, and/or
the holding power is more than 150 min.

9. The winding tape of claim 1, wherein the winding film comprises a solvent-free pressure-sensitive adhesive which is produced by coextrusion, melt coating or dispersion coating, the surface of the film to which the adhesive is applied being subjected to flame or corona pretreatment or being provided with adhesion promoter layer which is applied by coextrusion or coating.

10. The winding tape of claim 1, wherein the pressure-sensitive adhesive is polyacrylate-based.

11. The winding tape claim 1, wherein said winding tape is black.

12. The winding tape of claim 1, wherein the winding film is plasticizer-free or the plasticizer content sufficiently low that the fogging number is above 90%.

13. The winding tape of claim 1, wherein the film layer is produced by calender processing, in which case the melt index of the copolymer is below 5 g/10 min, processing, in which case the melt index of the copolymer is between 0.2 and 10 g/10 min.

14. The winding tape of claim 1, wherein the copolymer-containing film layer is blended with a further polymer.

15. The winding tape of claim 2, wherein the copolymer-containing film layer coextruded with a further film layer which comprises a an ethylene-based polymer, the ethylene-based polymer having a melt index of less than 10 g/10 min.

16. The winding tape of claim 1, wherein at least one layer of the winding tape is crosslinked.

17. A process for producing a the winding tape of claim 1, wherein
the winding film is wound to logs, which then, to increase the unwind force, are conditioned by heat treatment and subsequently slit into rolls, the unwind force of the material thus produced at 300 mm/min being higher by at least 50% than without such a measure, or ‘the winding film, for the purpose of increasing the unwind force, is subjected to a flame or corona treatment or is provided with a polar coextrusion layer and is subsequently processed into rolls, the unwind force of the material thus produced at 300 mm/min being higher by at least 50% than without such a measure, or
the winding film is slit by a process which leads, as a result of rough slit edges, to easier hand tearability, the breaking elongation of the winding-film rolls thus slit being lower by at least 30% than in the case of slitting with sharp blades,
the winding film is slit on an automatic slitter with defined knife advancement speed,
the winding film is wound on a core with an inside diameter of 30 to 40 mm.

18. A method for bundling, protecting, labeling, insulating or sealing ventilation pipes or wires or cables and for sheathing cable harnesses in vehicles or field coils for picture tubes, which comprises bundling, protecting, labeling, insulating or sealing said ventilation pipes or wires or cables or sheathing said cable harnesses in vehicles or field coils for picture tubes with the winding tape of claim 1.

19. An easy-tear, halogen-free winding tape composed of a film comprising a copolymer of
(a) α-olefin of the formula R—CH═CH₂, where R is hydrogen or an alkyl radical having 1 to 10 carbon atoms, and
(b) an α,β-ethylenically unsaturated carboxylic acid of 3 to 8 carbon atoms, and
(c) optionally a further monoethylenically unsaturated monomer, 10 to 90% of the carboxylic acid groups of the copolymer having been ionized as a result of neutralization with metal compounds.

20. The winding tape of claim 2, wherein said ions are alkali metals of said groups.

21. The winding tape of claim 20, wherein said alkali metal is sodium.

22. The winding tape of claim 3, wherein said fraction is at least 50% by weight.

23. The winding tape of claim 5, wherein the longitudinal draw ratio (ratio of film winding speed to melt speed in the die) is from 5 to 10, the longitudinal draw ratio divided by the frost line is greater than 0.2 cm⁻¹ and the blow-up ratio is situated in the range from 1.8 to 2.5.

24. The winding tape of claim 6, wherein said tensile strength in the machine direction is at least four times the tensile strength in the cross direction.

25. The winding tape of claim 7, wherein film layer thickness is from 55 to 100 μm,
breaking elongation is 30 to 400%,
tensile strength is 8 to 15 N/cm and/or
breakdown voltage is at least 5 kV/100 μm.

26. The winding tape of claim 8, wherein the amount of the adhesive layer is 18 to 28 g/m²,
the unwind force at an unwind speed of 300 mm/min is 1.6 to 4.0 N/cm and/or
the holding power is more than 150 min.

27. The winding tape of claim 26, wherein the unwind force at an unwind speed of 300 mm/min is 1.8 to 2.5 N/cm.

28. The winding tape of claim 9, wherein said adhesive is a pressure-sensitive dispersion adhesive.

29. The winding tape of claim 13, wherein the film layer is produced by calender processing, in which case the melt index of the copolymer is below 1 g/10 min and/or extrusion processing, in which case the melt index of the copolymer is between 0.5 and 5 g/10 min.

30. The winding tape of claim 29, wherein the film layer is produced by calender processing and the melt index of the copolymer is below 0.7 g/10 min.

31. The winding tape of claim 14, wherein said further polymer is an ethylene-based polymer.

32. The winding tape of claim 15, wherein said melt index is less than 6 g/10 min.

33. The winding tape of claim 16, wherein said at least one layer of the winding tape is crosslinked by ionizing radiation or by modification of a polymer with silane groups.
